(19) United States
(12) Patent Application Publication
(10) Pub. No.: US 2005/0086393 A1
(43) Pub. Date: Apr. 21, 2005

(54) Controlling power of network processor engines

(76) Inventors: David Qiang Meng, Union City, CA (US); Jian-Hui Huang, Mountain View, CA (US); Tim Chan, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/678,576

(22) Filed: Oct. 3, 2003

(51) Int. Cl. G06F 3/00

(52) U.S. Cl. 710/1

(57) ABSTRACT

In general, in one aspect, the disclosure includes a description of a method that includes accessing network traffic metering data and controlling power consumption of individual ones of a set of network processor processing engines based on the metering data.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately. For example, the header can include an address that identifies the packet's destination.

A given packet may “hop” across many different intermediate network devices (e.g., “routers”, “bridges” and/or “switches”) before reaching its destination. These intermediate devices often perform a variety of packet processing operations. For example, intermediate devices often perform packet classification to determine how to forward a packet further toward its destination or to determine the quality of service to provide.

These intermediate devices are carefully designed to keep apace the increasing deluge of traffic traveling across networks. Some architectures implement packet processing using “hard-wired” logic such as Application Specific Integrated Circuits (ASICs). While ASICs can operate at high speeds, changing ASIC operation, for example, to adapt to a change in a network protocol can prove difficult.

Other architectures use programmable devices known as network processors. Network processors enable software programmers to quickly reprogram network processor operations. Some network processors feature multiple processing engines to share packet processing duties. For instance, while one engine determines how to forward one packet further toward its destination, a different engine determines how to forward another. This enables the network processors to achieve speeds rivaling ASICs while remaining programmable.

### BRIEF DESCRIPTION OF THE DRAWINGS

FIGS. 1A and 1B are diagrams illustrating control of power consumed by processing engines of a network processor.

FIGS. 2A and 2B are diagrams of circuitry to control power consumed by processing engines of a network processor.

FIGS. 3 and 4 are flow-charts of processes to control power consumed by processing engines of a network processor.

FIG. 5 is a diagram of a network processor.

FIG. 6 is a diagram of a processing engine.

FIG. 7 is a diagram of a network forwarding device.

### DETAILED DESCRIPTION

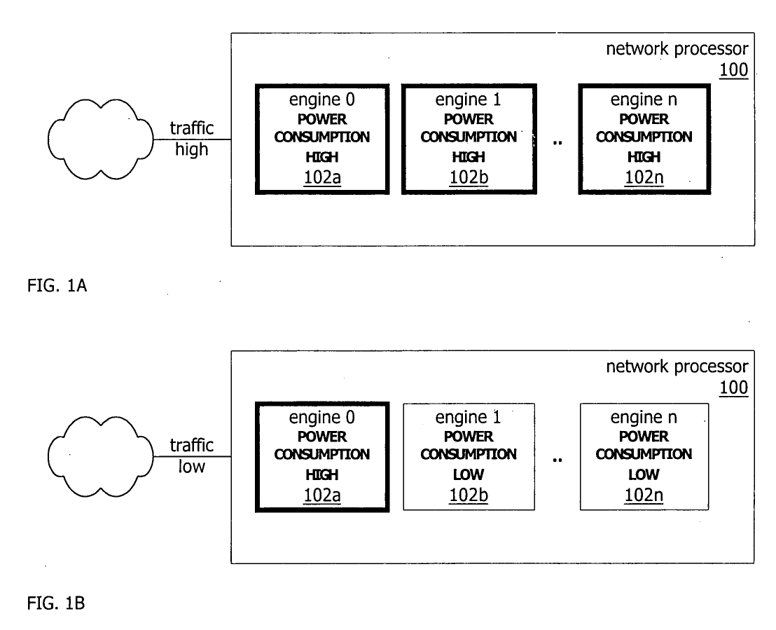

FIG. 1A depicts a network processor 100 that includes multiple processing engines 102a-102n. The engines 102a-102n may be programmed to perform a variety of packet processing operations such as packet classification, filtering, and forwarding, among others. As shown in FIG. 1A, when network traffic is high, packet processing duties may be shared by a large number of processing engines 102a-102n. For example, FIG. 1A depicts engines 102a-102n as having high power consumption (e.g., fully operational). However, when less network traffic passes through the network processor 100, fewer engines may be needed. For example, in FIG. 1B, when the traffic load decreases (e.g., when the number of packets received drops), the network processor 100 can reduce power consumed by engines 102b and 102n. This power management technique can, potentially, lower the average power consumption of the network processor 100. That is, near peak power consumption by each engine 102 regardless of traffic load consumes overall power at a nearly constant peak rate. Most of the time, however, the traffic load is less than peak. By managing power consumed by the engines based on network traffic, power consumption can be reduced by 50% or more. Reducing the power consumption of individual network processors can greatly reduce the power consumption of a device (e.g., a router) incorporating a large number of network processors. Additionally, this traffic-based power management scheme can, potentially, lengthen the life of a network processor, for example, by reducing heat and overall power use.

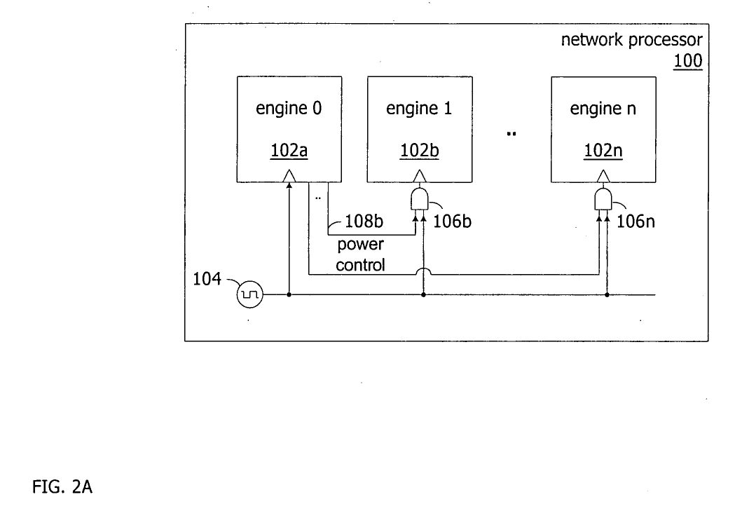

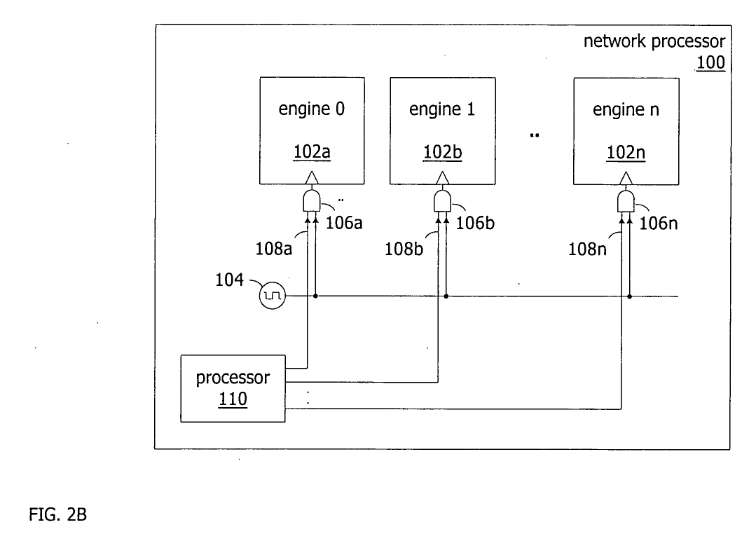

FIGS. 1A and 1B illustrate the underlying concept of engine 102 power management. The concept may be easily implemented in a wide variety of inexpensive ways. For example, FIG. 2A illustrates an implementation that controls engine 102b-102n power consumption by combining a clock 104 signal with a power control signal associated with a given engine 102b-102n. For example, in FIG. 2A, a logic gate 106b ANDs the clock 104 signal with a power control signal 108b. The gate 106b output is fed to the clock input of engine 102b. When the power control signal 108b is low, the engine 102b is effectively powered down and will cease operation, though the engine 102b will draw a negligible amount of power. When the power control signal 108b is high, the engine 102b will receive a “normal” clock 104 signal and execute instructions. Thus, by controlling the power control signals 108, software running on engine 102a (or other hardware or software) can control power consumed by the engines 102b-102n.

Another scheme to control engine power consumption is shown in FIG. 2B. In this implementation, engine 102 power consumption is controlled by a processor 110 other than an engine 102 (e.g., a general purpose processor or co-processor).

Changes in the set of engines 102b-102n operating will likely necessitate changes in packet processing operations. For example, the assignment of packets or packet processing operations to engines may be dynamically altered to reflect the changing set of operating engines.

FIGS. 2A and 2B are merely illustrations of two of a wide variety of possible implementations. For example, instead of a power control line for each engine 102 being controlled, a given power control line may connect to and control the power consumed by a set of multiple engines 102. Additionally, other implementations may feature other power consumption control mechanisms.

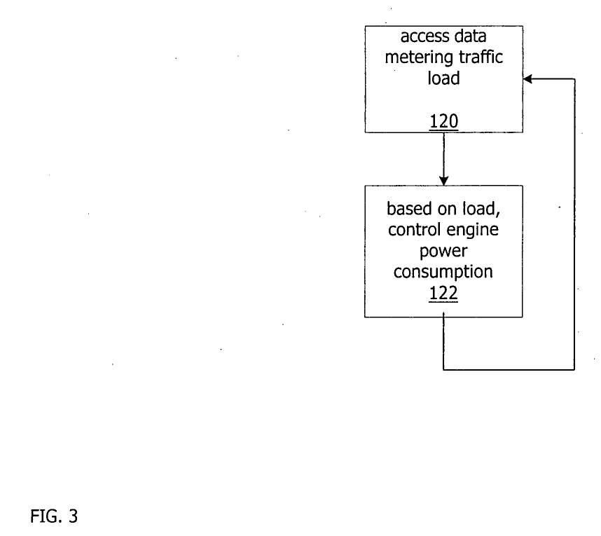

FIG. 3 depicts a flow-chart of a process to control power consumed by network processor engines. As shown, the process accesses data metering 120 the traffic load being handled by the network processor. For example, the network processor may maintain or access network statistics identifying how many bytes or packets were received and/or transmitted in a given interval. Such statistics may be maintained by the network processor or an attached network device such as a media access controller (MAC). Based on the traffic load, the process controls 122 engine power consumption. For example, for lesser traffic loads, one or more engines may be powered down.

The process may be implemented in a variety of ways. For example, a given packet processing design may assign different traffic flows to different engines. For instance, a packet may be classified as belonging to a particular Quality of Service (QoS) flow or a particular Transmission Control Protocol (TCP)/Internet Protocol (IP) flow (e.g., a flow based on IP source and destination addresses and TCP source and destination ports). Based on the flow, the packet may be assigned for processing by a particular engine. The flow/engine assignments may be made to concentrate the number of engines used to service the flows. For example, the flow or packet processing capacity of an engine may need to reach some level before an additional engine is powered up. Additionally, when the last flow currently assigned to an engine terminates, the engine may be powered down until again needed. Potentially, the traffic load of different flows may be individually measured, for example, to determine how many flows can be assigned to an engine.

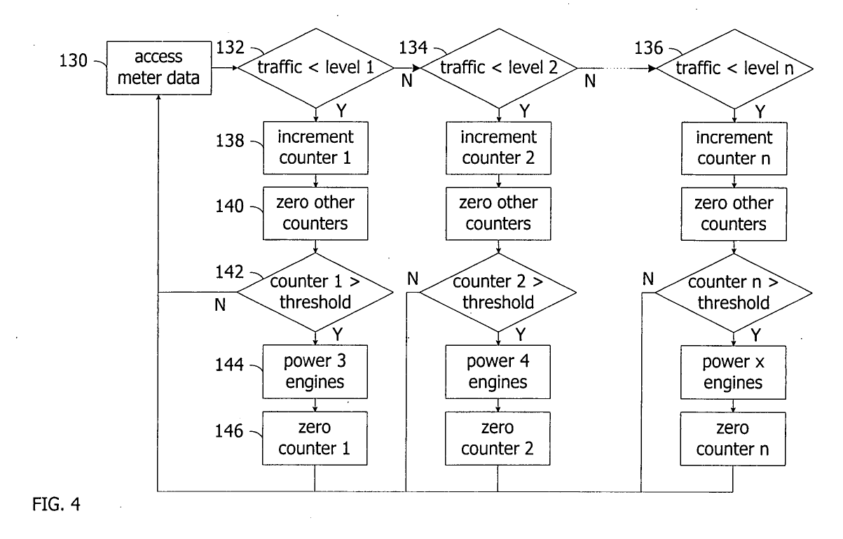

The techniques used to manage power consumption of the different engines may be done in a wide variety of ways. For example, FIG. 4 depicts a scheme that selects a number of engines to power based on the traffic load repeatedly falling within a given range. As shown in FIG. 4, a process accesses 130 traffic metering data. The traffic load is then classified 132, 134, 136 as falling within a given traffic level. Once a level is determined (e.g., level 1 in FIG. 4), the process can increment 138 a counter associated with that level and zero 140 the counters associated with other levels. The zero-ing 140 and subsequent comparison 142 of the level's counter with a threshold can ensure that the traffic load remains at a given level for some period of time before altering the set of engines being powered. This can avoid “thrashing” that very rapidly powers up and powers down a given engine. When the level counter exceeds 142 some threshold, the set of engines powered is set 144 to reflect the load and the counter for that level is zeroed 146. The process repeats for subsequent intervals.

The engines selected for a given level of traffic may be preset. For example, the power control circuitry may always power engines “1” and “2” when a given traffic level is detected. Alternately, the engines may be selected for powering based on a variety of factors such as existing load or flows.

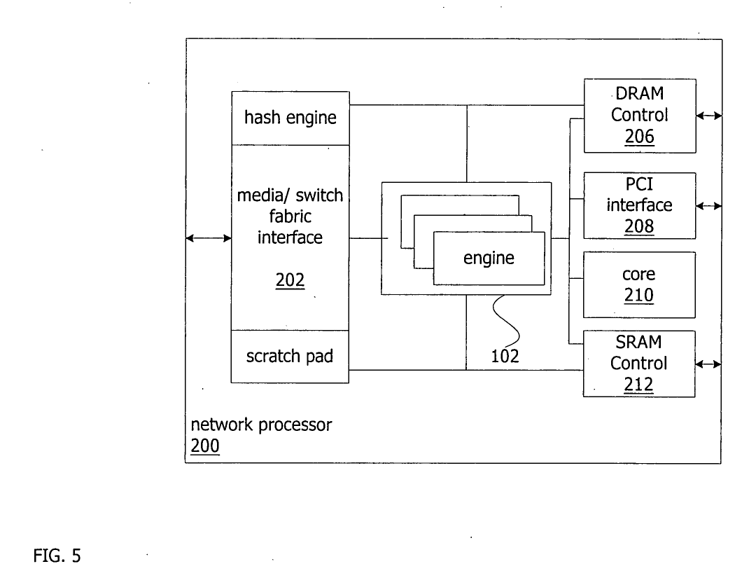

FIG. 5 depicts an example of network processor 200. The network processor 200 shown is an Intel® Internet exchange network Processor (IXP). Other network processors feature different designs. The network processor 200 shown features a collection of packet processing engines 102 on a single integrated circuit. Individual engines 102 may provide multiple threads of execution. As shown, the processor 200 also includes a core processor 210 (e.g., a StrongARM® XScale®) that is often programmed to perform “control plane” tasks involved in network operations. The core processor 210, however, may also handle “data plane” tasks.

As shown, the network processor 200 also features at least one interface 202 that can carry packets between the processor 200 and other network components. For example, the processor 200 can feature a switch fabric interface 202 (e.g., a Common Switch Interface (CSIX)) that enables the processor 200 to transmit a packet to other processor(s) or circuitry connected to the fabric. The processor 200 can also feature an interface 202 (e.g., a System Packet Interface (SPI) interface) that enables the processor 200 to communicate with physical layer (PHY) and/or link layer devices (e.g., MAC or framer devices). The processor 200 also includes an interface 208 (e.g., a Peripheral Component Interconnect (PCI) bus interface) for communicating, for example, with a host or other network processors. As shown, the processor 200 also includes other components shared by the engines 102 such as memory controllers 206, 212, a hash engine, and internal scratchpad memory.

The packet processing techniques described above may be implemented on a network processor, such as the IXP, in a wide variety of ways. For example, traffic metering and instructions to manage power consumption of the engines may be executed as one or more engine 102 threads. The metering and control operations may operate on the same engine 102 to minimize the “footprint” of the scheme and permit powering down of all but one of the engines 102 at times. An alternate scheme (e.g., FIG. 2B) may implement the power control circuitry in the core 210 or other hardware, potentially, permitting powering down of all engines 102.

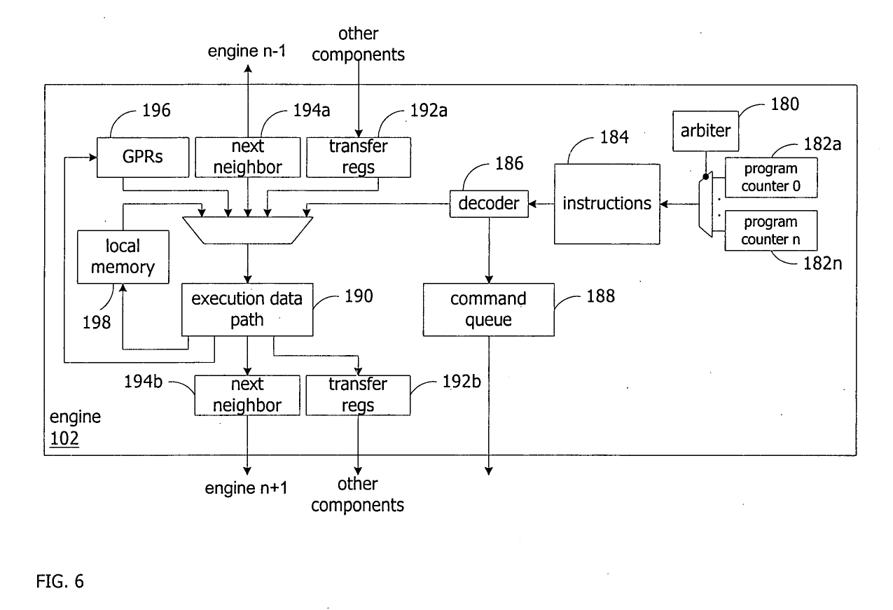

FIG. 6 illustrates a sample engine 102 architecture. The engine 102 may be a Reduced Instruction Set Computing (RISC) processor tailored for packet processing. For example, the engines 102 may not provide floating point or integer division instructions commonly provided by the instruction sets of general purpose processors.

The engine 102 may communicate with other network processor components (e.g., shared memory) via transfer registers 192a, 192b that buffer data to send to/received from the other components. The engine 102 may also communicate with other engines 102 via neighbor registers 194a, 194b wired to adjacent engine(s).

The sample engine 102 shown provides multiple threads of execution. To support the multiple threads, the engine 102 stores program counters 182 for each thread. A thread arbiter 182 selects the program counter for a thread to execute. This program counter is fed to an instruction store 184 that outputs the instruction identified by the program counter to an instruction decode 186 unit. The instruction decode 186 unit may feed the instruction to an execution unit (e.g., an Arithmetic Logic Unit (ALU)) 190 for processing or may initiate a request to another network processor component (e.g., a memory controller) via command queue 188. The decoder 186 and execution unit 190 may implement an instruction processing pipeline. That is, an instruction may be output from the instruction store 184 in a first cycle, decoded 186 in the second, instruction operands loaded (e.g., from general purpose registers 196, next neighbor registers 194a, transfer registers 192a, and/or local memory 198) in the third, and executed by the execution data path 190 in the fourth. Finally, the results of the operation may be written (e.g., to general purpose registers 196, local memory 198, next neighbor registers 194b, or transfer registers 192b) in the fifth cycle. Many instructions may be in the pipeline at the same time. That is, while one is being decoded 186 another is being loaded from the instruction store 104. The engine 102 components may be clocked by a common clock input.

The engine 102 can implement engine power management in a variety of ways. For example, a thread operating on the engine 102 may maintain and alter values of an array of power control data. For example, each bit of a register may represent whether a particular engine should be powered up (bit=1) or down (bit=0). The values of the register may be sent to the engines via power control lines (e.g., as shown in FIGS. 2A and 2B).

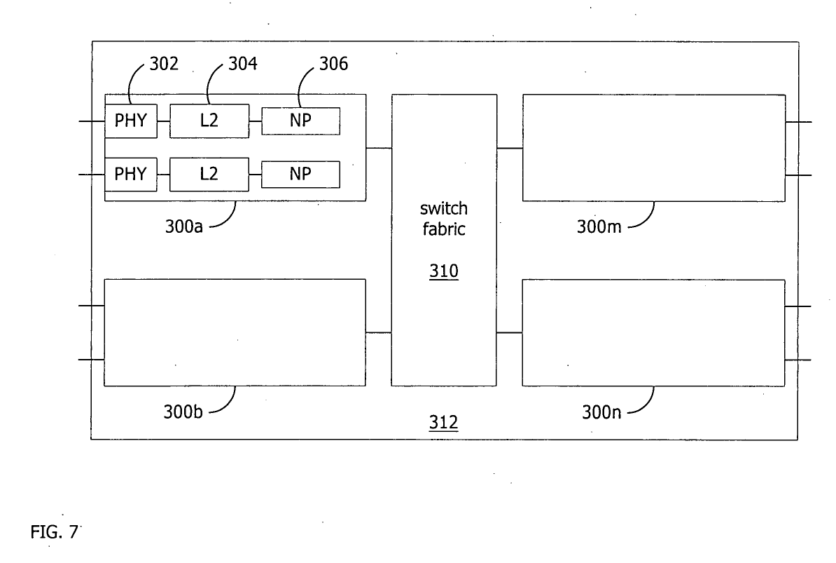

FIG. 7 depicts a network device 312 incorporating techniques described above. As shown, the device features a collection of line cards 300 (“blades”) interconnected by a switch fabric 310 (e.g., a crossbar or shared memory switch fabric). The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual line cards (e.g., 300a) may include one or more physical layer (PHY) devices 302 (e.g., optic, wire, and wireless PHYs) that handle communication over network connections. The PHYs translate between the physical signals carried by different network mediums and the bits (e.g., “0”-s and “1”-s) used by digital systems. The line cards 300 may also include framer devices (e.g., Ethernet, Synchronous Optic Network (SONET), High-Level Data Link (HDLC) framers or other “layer 2” devices) 304 that can perform operations on frames such as error detection and/or correction. The line cards 300 shown may also include one or more network processors 306 that perform packet processing operations for packets received via the PHY(s) 302 and direct the packets, via the switch fabric 310, to a line card providing an egress interface to forward the packet. Potentially, the network processor(s) 306 may perform “layer 2” duties instead of the framer devices 304.

While FIGS. 5-7 described specific examples of a network processor, engine, and a device incorporating network processors, the techniques may be implemented in a variety of hardware, firmware, and/or software architectures including network processors, engines, and network devices having designs other than those shown. Additionally, the techniques may be used in a wide variety of network devices (e.g., a router, switch, bridge, hub, traffic generator, and so forth). Further, engine power consumption need not be all or (nearly) nothing. For example, different frequency clock signals may be fed to the engines.

The term packet was sometimes used in the above description to refer to an IP packet encapsulating a TCP segment. However, the term packet also encompasses a frame, TCP segment, fragment, Asynchronous Transfer Mode (ATM) cell, and so forth, depending on the network technology being used.

The term circuitry as used herein includes hardwired circuitry, digital circuitry, analog circuitry, programmable circuitry, and so forth. The programmable circuitry may operate on computer programs. Such computer programs may be coded in a high level procedural or object oriented programming language. However, the program(s) can be implemented in assembly or machine language if desired. The language may be compiled or interpreted. Additionally, these techniques may be used in a wide variety of networking environments.

Other embodiments are within the scope of the following claim.

1. A network processor, the network processor comprising:
at least one interface to at least one device carrying network traffic;
a set of processing engines; and
circuitry to control power consumed by individual ones of the set of processing engines based on network traffic handled by the network processor.

2. The network processor of claim 1, wherein the circuitry comprises multiple power control lines, an individual one of the power control lines to control power consumption of at least one of the processing engines.

3. The network process of claim 2, wherein the individual power control line controls power consumption of only one of the processing engines.

4. The network processor of claim 2, wherein the circuitry comprises at least one logic gate coupled to the clock input of a one of the processing engines, the at least one logic gate operating on a one of the power control lines and a clock signal.

5. The network processor of claim 1, wherein the circuitry comprises circuitry to access network traffic meter data.

6. The network processor of claim 4, wherein the circuitry comprises circuitry to meter network traffic in individual traffic flows.

7. The network processor of claim 1,
further comprising at least one shared memory controller communicatively coupled to the processing engines; and
wherein the processing engines comprise multi-threaded processing engines.

8. The network processor of claim 1,
wherein the circuitry comprises computer program instructions, disposed on a computer readable medium, the instructions for causing at least one of the processing engines to determine engine(s) to power down based on the metering.

9. A method, comprising:
accessing network traffic metering data; and
controlling power consumption of individual ones of a set of network processor processing engines based on the metering data.

10. The method of claim 9, wherein controlling power consumption comprises sending signals over power control lines, an individual one of the power control lines being associated with a particular processing engine.

11. The method of claim 10, wherein controlling power consumption comprises AND-ing the signal sent over the individual power control line with a clock signal.

12. The method of claim 9, wherein the processing engines comprise at least one engine programmed to perform packet classification.

13. The method of claim 9,
wherein the processing engines comprise multi-threaded processing engines.

14. The method of claim 9,
further comprising metering the network traffic; and
wherein controlling power consumption comprises determining engines to power down based on the metering.

15. A computer program product, disposed on a computer readable medium, the program including instructions for causing a processor to:
access network traffic metering data; and
control power consumption of individual ones of a set of network processor processing engines based on the metering data.

16. The program of claim 15, wherein the instructions to control power consumption comprise instructions to send signals over power control lines, an individual one of the power control lines being associated with a particular processing engine.

17. The program of claim 15, further comprising instructions to meter network traffic.

18. The program of claim 15, wherein the program instructions comprise instructions for a thread executed by a one of the set of processing engines.

19. The program of claim 15, wherein the instructions to control power consumption comprise instructions to cause the processor to determine engines to power down.

20. A network forwarding device, the device comprising:
at least one physical layer (PHY) device;
at least one media access control (MAC) device communicatively coupled to at least one of the at least one PHY devices;
at least one network processor communicatively coupled to the at least one MAC device, the network processor comprising:
a set of processing engines; and
circuitry to control power consumption of individual ones of the set of processing engines based on network traffic handled by the network processor.

21. The device of claim 20, wherein the circuitry comprises power control lines, an individual power control line being associated with at least one processing engine.

22. The device of claim 20, wherein the circuitry comprises at least one logic gate coupled to the clock input of a one of the processing engines, the logic gate operating on a one of the power control lines associated with the one of the processing engines and a clock signal.

23. The device of claim 20, wherein the circuitry comprises circuitry to meter network traffic.

24. The device of claim 20,
wherein the network processor further comprises a shared memory controller communicatively coupled to the processing engines; and
wherein the processing engines comprise multi-threaded processing engines.

25. The device of claim 20, further comprising computer program instructions, disposed on a computer readable medium, for causing at least one of the processing engines to:
meter network traffic;
determine which engines to power based on the metering; and
set data based on the determination.

26. The device of claim 25, wherein the data comprises an array of data elements, individual elements identifying a level of power consumption of a corresponding engine.

27. The device of claim 20,
wherein the PHY(s), MAC(s), and network processor(s) comprise a line card;
wherein the device comprises multiple line cards; and
further comprising a switch fabric interconnecting the multiple line cards.
